(19) United States
(12) Patent Application Publication
(10) Pub. No.: US 2007/0169581 A1
(43) Pub. Date: Jul. 26, 2007

(54) Gear shift lever and knob

(76) Inventor: Michael Bielen, East Brunswick, NJ (US)

Correspondence Address: Daniel Kirshner, Esq., 199 Route 18 South, E Brunswick, NJ, 08816, US

(21) Appl. No.: 11/338,301

(22) Filed: Jan. 24, 2006

(51) Int. Cl. G05G 1/10

(52) U.S. Cl. 74/543

(57) ABSTRACT

A gear shift lever for use with a motor vehicle such as a motorcycle or an automobile that includes a handle portion (knob) that is sized and configured to receive a gauge and more specifically a tachometer. The handle portion of the gear shift lever has a generally cylindrical interior of a chosen predetermined diameter wherein the chosen diameter is appropriate to receive the specific gauge. The gauge is inserted into the handle/knob portion of the gear shifter wherein it fits snugly and with the face of the gauge substantially flush with the top rim of the knob. The handle/knob has a threaded attachment portion which permits attachment to a hollow shifter arm member which in turn is connected to the transmission of the vehicle. Wires and/or mechanical connections from the gauge are fed through the threaded attachment portion and through the hollow shifter arm for connection to take the reading for the gauge.

### FIELD OF THE INVENTION

The present invention is a gear shift lever which specifically includes a newly designed knob at its proximal end. More specifically, the present invention is a gear shift lever for a motor vehicle such as an automobile or motorcycle and includes a cylindrical gear shift handle (knob) for receiving a tachometer or other such gauge on its proximal end and a hollow shifter arm for receiving the gauge's wiring or mechanical connections.

### BACKGROUND OF THE INVENTION

The present invention gear shift lever/knob is specifically utilized by custom motorcycle or automobile fabricators and interacts with a particular tachometer. Nevertheless, the principals employed herein can be employed with a variety of after-market electronic or mechanical tachometers and other like gauges.

There are known in the prior art several devices that incorporate a gauge into an article of manufacture, none of which provide the functionality and advantages of the present invention. For example, U.S. Pat. No. 4,670,988 issued to Baxter discloses a compass mechanism incorporated into a handle structure. U.S. Pat. No. 3,059,496 issued to Jones shows a steering shaft mounted speedometer. U.S. Pat. No. 5,557,981 shows a gearshift lever with a contoured end and a channel region.

Therefore, it is the objective of this invention to provide a gear shift lever that accepts a tachometer or other gauge at its proximal end and means to wire or mechanically attach the gauge to the transmission of the vehicle. It will further be an objective and advantage to provide custom motorcycle or vehicle fabricators a device which improves the appearance of the customization.

Other objectives, advantages and novel features, and further scope of applicability of the present invention will be set forth in the detailed description to follow, taken in conjunction with the accompanying drawings, will become apparent to those skilled in the art of custom vehicle fabrication upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a gear shift lever for use with a motor vehicle such as a motorcycle or an automobile. The gear shifter includes a handle portion (knob) that is sized and configured to receive a gauge and more specifically a tachometer. The handle portion of the gear shift lever has a generally cylindrical interior of a chosen predetermined diameter wherein the chosen diameter is appropriate to receive the specific gauge. The gauge is inserted into the handle/knob portion of the gear shifter wherein it fits snugly and with the face of the gauge substantially flush with the top rim of the knob. The handle/knob has a threaded attachment portion which permits attachment to a hollow shifter arm member which in turn is connected to the transmission of the vehicle. Wires and/or mechanical connections from the gauge are fed through the threaded attachment portion and through the hollow shifter arm for connection to take the reading for the gauge.

### BRIEF DESCRIPTION OF THE DRAWINGS

For a better understanding of the invention, reference is made herein to the following description of an exemplary embodiment thereof, considered in conjunction with the accompanying drawings, in which:

FIG. 1 is front elevational view of the present invention gear shift lever showing the invention in an exploded condition.

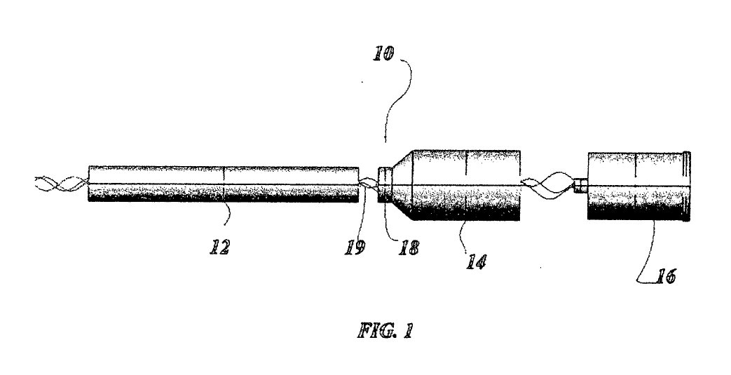

FIG. 2 is a front elevational view of the present invention gear shift lever.

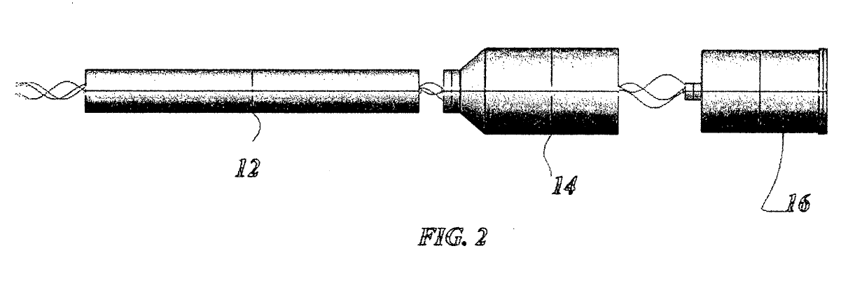

FIG. 3 is a front elevational view of the handle/knob portion of the present invention gear shift lever.

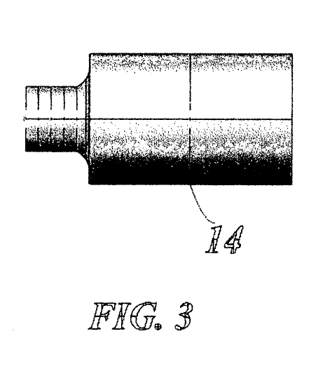

FIG. 4 is a cross-sectional view of the handle/knob portion of the present invention gear shift lever.

### DETAILED DESCRIPTION OF THE INVENTION

The present invention is a gear shift lever for a motor vehicle that includes a tachometer or other gauge receptacle at the proximal end (i.e. the end that is closest to the driver.) As disclosed herein, the gear shift lever is shown with the integrated tachometer.

Referring to the figures, the gear shift lever of the present invention is shown generally as reference number 10. The gear shift lever includes the shifter arm 12, the gear shift handle 14, and the tachometer or other gauge 16.

The gear shift handle 14 is generally cylindrical and is sized and configured to receive the gauge 16. As such, it will be understood that the interior side wall of the gear shift handle is slightly larger that the exterior diameter of the gauge 16 which has a cylindrical exterior wall, and is just deep enough that when the gauge is in place, the gauge's top surface will be flush with the rim of the handle. As such, the gauge fits snugly into the gear shift handle with the display face of the gauge flush with the top rim of the handle. Although, the material from which the handle is constructed is not critical to the invention, as disclosed herein, the handle is formed from 1018 carbon steel round billet stock. The distal end of the gear shift handle includes means for attachment to the shifter arm wherein the means for attachment is a threaded aperture portion 18 which is drilled through and tapped for ⅝×18 screw threads. The threaded aperture is utilized for attachment of the gear shift handle to the shifter arm 12. The threaded aperture is also used as a means for routing the wiring 19 or mechanical linkage for the gauge 16 so that the gauge may be linked to the transmission of the vehicle. Furthermore, as is seen in the drawings, the threaded aperture portion of the knob/handle has a diameter that is smaller than the diameter of the rest of the knob. In the embodiment disclosed herein, the gear shift handle is chrome plated for cosmetics and to prevent rusting.

The gear shift handle is screwably attached to the shifter arm 12. As such, the shifter arm includes corresponding male ⅝×8 screw threads on its proximal end so that it can readily be screwed onto the threaded aperture 18 of the gear shift handle. It will be understood that the distal end of the shifter arm is mechanically connected to the transmission of the vehicle in order to shift gears. The shifter arm is hollow, so that the wiring 19 or mechanical linkage from the gauge 16 may be routed therethrough.

The gauge 16 is a prior art gauge and is typically a tachometer. As shown herein, the tachometer is an MBB German-made tachometer, although it is within the scope of this disclosure to utilize other tachometers, speedometers or other gauges which measure engine performance. The important aspect is that the gauge and the gear shift handle are chosen to coordinate with each other in the sense that the gear shift handle needs to be sized and configured appropriately depending on the choice of gauge. Now, the wiring 19 or mechanical linkage of the gauge is fed through the threaded aperture 18 on the distal end of the gear shift handle and through the hollow tube of the shifter arm 12. The wiring or mechanical linkage is mated to the wheel of the vehicle or its transmission or other such typical attachment in order to perform the required measurement.

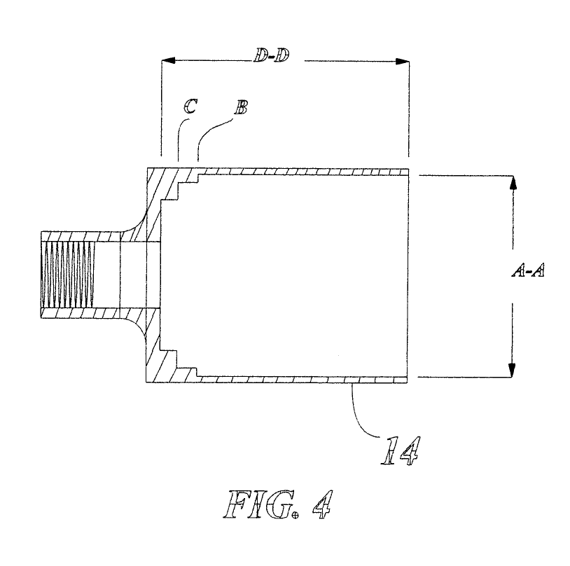

Looking more closely at the gear shift handle which is depicted in a cross-sectional view in FIG. 4. The section of the gear shift handle that receives the tachometer or gauge has an internal diameter of approximately 1.885 inches as shown as A-A on the Figure, which dimension is chosen to properly receive the outer cylindrical housing of the tachometer or gauge. The diameter of the gear shift knob steps down at points B and C. Specifically, the interior diameter of the gear shift handle at point B is 1.730 inches and the interior diameter at point C is 1.410 inches. As such, the tachometer will fit snugly into the handle portion of the gear shift. Although the exterior diameter of the handle portion is less critical, as shown here, the exterior diameter is 2.000 inches. Furthermore, the overall depth of the handle D-D is 2.365 inches which correspondingly steps down at points C and B to 2.205 inches and 2.010 inches. As such, the gauge will reside inside the handle so that the face of the gauge is substantially flush with the top rim of the handle.

To utilize the present invention, the custom vehicle fabricator or other end user inserts the gauge 16 into the handle/knob section 14 so that it fits snugly with the gauge's face substantially flush with the top rim of the handle The wiring 19 or mechanical linkage from of the gauge is fed through the threaded portion 18 of the handle and then though the hollow interior of the shifter arm 12. Now, the handle/knob is screwably attached to the shifter arm. Finally, the shifter arm is connected to the transmission of the vehicle to shift gears and the wiring or mechanical linkage of the gauge is attached to perform its measurements.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope of the invention.

What is claimed:

1. A gear shift assembly comprising;
a gauge, said gauge having a predetermined exterior diameter,
a gear shift arm, said gear shift arm including a hollow shaft, and
a gear shift handle, said gear shift handle having a gauge receiving section that has a generally cylindrical interior that is sized and configured to receive said gauge and has an interior diameter slightly larger than said predetermined exterior diameter of said gauge, said gear shift handle including means for attachment to said gear shift arm.

2. A gear shift lever comprising a gear shift handle section, said gear shift handle section having a generally cylindrical interior of a predetermined diameter for receiving a gauge of a predetermined exterior diameter wherein said predetermined diameter of said handle section is chosen so that said gauge fits into said handle snugly.
